(19) United States
(12) Patent Application Publication
(10) Pub. No.: US 2026/0145342 A1
(43) Pub. Date: May 28, 2026

(54) ROBOT CONTROL SYSTEM, ROBOT CONTROL METHOD, AND ROBOT CONTROL PROGRAM

(71) Applicant: NEC Corporation, Tokyo (JP)

(72) Inventor: Mizuho KATAYAMA, Tokyo (JP)

(73) Assignee: NEC Corporation, Tokyo (JP)

(21) Appl. No.: 19/385,519

(22) Filed: Nov. 11, 2025

(30) Foreign Application Priority Data
Nov. 28, 2024 (JP) 2024-207159

(51) Int. Cl. B25J 13/08; B25J 9/16

(52) U.S. Cl. CPC B25J 13/089; B25J 9/1653; B25J 9/1697

(57) ABSTRACT

The robot control system includes an environment information acquisition unit that acquires environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit, and a control unit that controls a robot having the arm unit in accordance with an operation plan generated based on the environment information.

This application is based upon and claims the benefit of priority from the prior Japanese Patent Application No. 2024-207159, filed Nov. 28, 2024, the entire contents of which are incorporated herein by reference.

### BACKGROUND OF INVENTION

### Field of the Invention

This disclosure relates to a robot control system, a robot control method, and a robot control program.

### Description of the Related Art

As a technology related to robot control, for example, Patent Literature 1 discloses a harvesting robot system that performs harvesting of crops such as fruits growing on trees.

The harvesting robot system described in Patent Literature 1 acquires data related to positions of crops and positions of obstacles using a sensor device, and controls a manipulator in such a way that it moves to a harvestable position of a crop without colliding with obstacles.
[Patent Literature 1] Japanese Patent Application Publication No. 2023-012812

### SUMMARY OF INVENTION

In Patent Literature 1, it is described to use an RGB-D (Red Green Blue and Depth) sensor as a sensor device having an imaging unit to capture a subject and a measuring unit to measure a distance to surrounding objects. However, compared with a general RGB (Red Green Blue) camera, an RGB-D camera capable of also acquiring depth information is expensive, and low-price models have unstable supply. Therefore, a system using RGB-D cameras becomes high cost.

The disclosure has been made in view of these problems. An example object of the disclosure is to provide a robot control system, a robot control method, and a robot control program that can achieve robot control at low cost.

A robot control system according to an example aspect of the disclosure includes an environment information acquisition unit that acquires environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit, and a control unit that controls a robot having the arm unit in accordance with an operation plan generated based on the environment information.

A robot control method according to an example aspect of the disclosure performed by a computer and includes acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit, and controlling a robot having the arm unit in accordance with an operation plan generated based on the environment information.

A robot control program according to an example aspect of the disclosure for causing a computer to execute acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit, and controlling a robot having the arm unit in accordance with an operation plan generated based on the environment information.

According to the present disclosure, robot control can be achieved at low cost.

### BRIEF DESCRIPTION OF THE DRAWINGS

FIG. 1 It depicts a block diagram that explains an example robot control system.

FIG. 2A It depicts an explanatory diagram that explains one example method of acquiring depth information and an RGB image.

FIG. 2B It depicts an explanatory diagram that explains one example method of acquiring depth information and an RGB image.

FIG. 2C It depicts an explanatory diagram that explains one example method of acquiring depth information and an RGB image.

FIG. 3 It depicts an explanatory diagram that explains one example method of acquiring depth information based on posture sensor data.

FIG. 4 It depicts an explanatory diagram that explains an outline of operations of the robot control system.

FIG. 5 It depicts a flowchart that explains operations of the robot control system.

FIG. 6 It depicts a flowchart that explains operations of a low accuracy environment information acquisition unit.

FIG. 7 It depicts a flowchart that explains operations of an active environment information acquisition unit.

FIG. 8 It depicts a block diagram that explains a hardware configuration of a computer that achieves the robot control system.

FIG. 9 It depicts a block diagram that explains principal parts of the robot control system.

### DESCRIPTION OF THE PREFERRED EMBODIMENTS

A decline of labor force due to labor shortages is beginning to become apparent in various fields. In particular, in the logistics industry, there are many operations that depend on people, and automation through the introduction of picking robots and the like is required. However, due to technical and cost constraints, introduction has not progressed.

By applying a teaching-less system that can automate teaching work for setting work goals and procedures for a robot, introduction and utilization of robots become easier. However, this teaching-less system requires environment information that indicates, for example, a shape and a position of a target object. Although there is a method that uses a 3D (three-dimensional) camera to automatically recognize environment information, a 3D camera is more expensive than a general RGB camera, and low-price models have unstable supply. Therefore, a system using a 3D camera becomes high cost.

One of the objectives of the present disclosure is to achieve a teaching-less robot control system at low cost. The robot control system of the present disclosure adopts relatively inexpensive sensing devices. As a result, it becomes easy to utilize the system in combination with an existing system or to introduce a new system.

Hereinafter, example embodiments of the present disclosure are explained with reference to drawings. In each drawing, the same reference numerals are assigned to the same or elements associated to each other, and duplicate explanation is omitted as necessary for clarification. Unless otherwise specifically explained, values such as predetermined values and thresholds are previously stored in a storage device accessible from a device that uses the values. Unless otherwise specifically explained, a storage unit is constituted by any number of one or more storage devices.

### Example Embodiment 1

### Explanation of Configuration

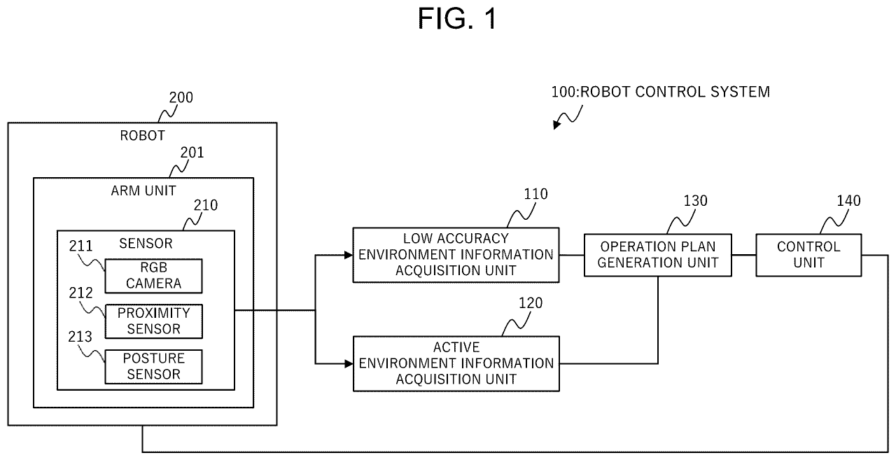

A robot control system of the present example embodiment is explained. FIG. 1 is a block diagram that explains an example robot control system. A robot control system 100 of the present example embodiment includes a low accuracy environment information acquisition unit 110, an active environment information acquisition unit 120 configured to actively acquire environment information, an operation plan generation unit 130, a control unit 140, and a robot 200.

The block diagram shown in FIG. 1 does not limit a configuration of the robot control system 100 according to the present disclosure. For example, the low accuracy environment information acquisition unit 110, the active environment information acquisition unit 120, the operation plan generation unit 130, and the control unit 140 may be included in the robot 200. That is, hardware that achieves each functional configuration unit of the low accuracy environment information acquisition unit 110, the active environment information acquisition unit 120, the operation plan generation unit 130, and the control unit 140, or a combination of hardware and software, may be mounted on the robot 200.

The robot 200 is a robot to be controlled by the robot control system 100. The robot 200 is, for example, an industrial robot such as a picking robot, a welding robot, an assembly robot, a painting robot, a polishing or cutting robot, or an inspection robot.

The robot 200 has an arm unit 201. The arm unit 201 is a mechanism for performing a specific operation such as manipulation or movement of an object. Hereinafter, an object to be worked by the arm unit 201 is also referred to as a target object.

For example, the arm unit 201 has a structure modeled on a human arm and is constituted by a plurality of joint units and link units. An end effector suitable for an application of the robot 200 is attached to a tip of the arm unit 201. The robot 200 may be constituted only by the arm unit 201. That is, the robot 200 may be an arm type robot.

The arm unit 201 is equipped with an RGB camera 211, a proximity sensor 212, and a posture sensor 213. The RGB camera 211 and the proximity sensor 212 are mounted, for example, on a tip portion of the arm unit 201. The posture sensor 213 is mounted, for example, on a joint unit of the arm unit 201. When the arm unit 201 has a plurality of joint units, posture sensors 213 associated to the respective joint units are mounted for the respective joint units.

The RGB camera 211 is a camera that acquires a two-dimensional color image using three primary colors of red, green, and blue, hereinafter also referred to as an RGB image. The RGB camera 211 has a function to acquire the RGB image of a captured target object.

The proximity sensor 212 is a sensor that detects that an object has approached within a predetermined range. The proximity sensor 212 can sense a presence and a distance of an object without contact. That is, the proximity sensor 212 is capable of detecting proximity of the target object. When the proximity sensor 212 detects proximity of the target object, the proximity sensor 212 outputs proximity sensor data indicating that the proximity has been detected.

The posture sensor 213 is a sensor that measures a posture of the arm unit 201. Specifically, the posture sensor 213 is a sensor that measures a joint angle of a joint unit associated to it. The posture sensor 213 is realized, for example, by an angle sensor such as a rotary encoder. The posture sensor 213 outputs posture sensor data indicating a measurement result.

The low accuracy environment information acquisition unit 110 has a function to acquire environment information based on an RGB image acquired by the RGB camera 211. The environment information in the present example embodiment corresponds to information of an outside world of the robot 200. The environment information includes, for example, information indicating an environment of the outside world such as terrain of the outside world and positions, shapes, and coordinates of objects existing in the outside world. The low accuracy environment information acquisition unit 110 performs, for example, three-dimensional reconstruction processing using an RGB image and acquires environment information including three-dimensional spatial information related to a target object. The low accuracy environment information acquisition unit 110 can also acquire environment information related to a target object based on an RGB image acquired by an RGB camera different from the RGB camera 211 mounted on the arm unit 201. This different RGB camera is a camera installed at a position from which an environment where the robot 200 performs work can be viewed at a glance, for example, and capable of imaging an overall scene of a work environment including the target object. The robot control system 100 may have a configuration that includes this different RGB camera instead of the RGB camera 211 mounted on the arm unit 201, or in addition to the RGB camera 211 mounted on the arm unit 201.

The three-dimensional reconstruction processing is processing for reconstructing a three-dimensional shape and a position of an object or an environment from two-dimensional image data or sensor data. The low accuracy environment information acquisition unit 110 performs three-dimensional reconstruction processing using, for example, Visual SLAM (Simultaneous Localization and Mapping) technology that performs self localization and environment map creation. By performing such three-dimensional reconstruction processing, the low accuracy environment information acquisition unit 110 acquires three-dimensional spatial information such as a three-dimensional point cloud or a three-dimensional map indicating, for example, a shape of a target object.

The active environment information acquisition unit 120 has a function to operate the arm unit 201 and to acquire depth information indicating a distance to a target object and an RGB image of the target object captured by the RGB camera 211. The active environment information acquisition unit 120 also has a function to acquire environment information based on the acquired depth information and the RGB image. The active environment information acquisition unit 120 can acquire, for example, information indicating three-dimensional coordinates of the target object as environment information.

The active environment information acquisition unit 120 operates the arm unit 201 to acquire depth information and an RGB image. In this case, the active environment information acquisition unit 120 can operate the arm unit 201 based on existing environment information. The existing environment information is, for example, environment information acquired by the low accuracy environment information acquisition unit 110 or environment information acquired by the active environment information acquisition unit 120 in the past. The active environment information acquisition unit 120 can also operate the arm unit 201 based on exploration range definition information in which an exploration range is defined. This exploration range may be defined by a user, or may be automatically defined based on environment information, operation plans, and control results based on operation plans acquired in the past. That is, the active environment information acquisition unit 120 can operate the arm unit 201 to acquire depth information and an RGB image based on either one or both of the existing environment information and the exploration range definition information. In this case, the active environment information acquisition unit 120 may transmit a control signal of operation directly to the robot 200 or may transmit it via the control unit 140.

The active environment information acquisition unit 120 moves the arm unit 201 in various directions and postures until the proximity sensor 212 detects proximity, scans the target object, and acquires depth information. Specifically, the active environment information acquisition unit 120 inputs proximity sensor data at a time when the proximity sensor 212 detects proximity to the target object. The active environment information acquisition unit 120 also inputs posture sensor data indicating a posture of the arm unit 201 at that time, for example, joint angles of the respective joint units. Then, based on the posture sensor data at the time when the proximity sensor 212 detects proximity to the target object, the active environment information acquisition unit 120 calculates a distance between an arbitrary origin, for example a base unit of the arm unit 201, and the target object.

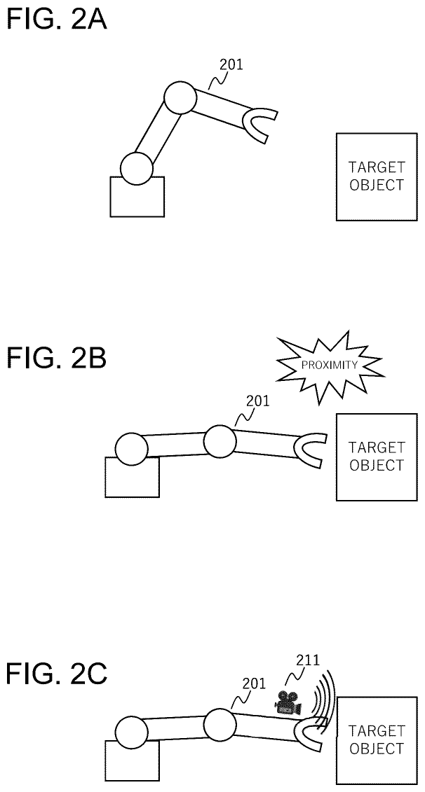

FIG. 2 is an explanatory diagram that explains one example method of acquiring depth information and an RGB image. FIG. 2 shows procedures for acquiring depth information and an RGB image to acquire environment information of a space in which a target object, a box in the example shown in FIG. 2, exists.

FIG. 2A shows a state of the arm unit 201 at a time of start of acquisition. The active environment information acquisition unit 120 operates the arm unit 201 in various directions and postures until the proximity sensor 212 detects proximity. Thereafter, as shown in FIG. 2B, when the proximity sensor 212 detects proximity to the target object, the active environment information acquisition unit 120 stops operation of the arm unit 201 or operates the arm unit 201 in such a way that it does not contact the target object. The active environment information acquisition unit 120 acquires posture sensor data indicating a posture of the arm unit 201 at that time, for example, joint angles of the respective joint units. Then, for example, based on a joint angle of a joint unit of the arm unit 201 included in the posture sensor data and a link length known in advance, the active environment information acquisition unit 120 calculates a distance between an arbitrary origin and the target object. Information indicating link lengths is stored in advance, for example, in the robot control system 100 or in an external storage unit (not shown). By repeating such processing, the active environment information acquisition unit 120 can calculate distances between an arbitrary origin and various parts of the target object.

Further, as shown in FIG. 2C, the active environment information acquisition unit 120 acquires an RGB image of the target object captured by the RGB camera 211 mounted on the arm unit 201. The active environment information acquisition unit 120 can acquire RGB images of the target object captured from a plurality of different viewpoints by adjusting a position and a posture of the arm unit 201 and thereby changing a position and a posture of the RGB camera 211.

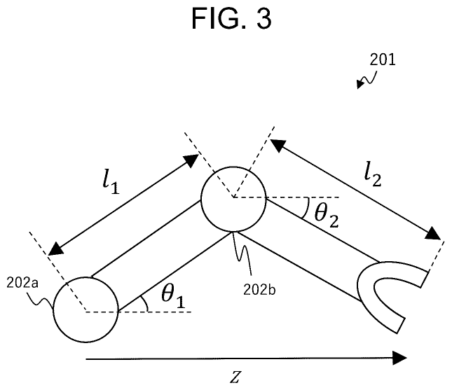

FIG. 3 is an explanatory diagram that explains one example method of acquiring depth information based on posture sensor data. FIG. 3 shows a posture of the arm unit 201 at a time when the proximity sensor 212 detects proximity to the target object. The arm unit 201 shown in FIG. 3 has a first joint unit 202a and a second joint unit 202b. The arm unit 201 shown in FIG. 3 is equipped with a first posture sensor 213a associated to the first joint unit 202a and a second posture sensor 213b associated to the second joint unit 202b.

At a time when the proximity sensor 212 detects proximity, the active environment information acquisition unit 120 acquires posture sensor data output by the first posture sensor 213a and the second posture sensor 213b. Based on posture sensor data output by the first posture sensor 213a, the active environment information acquisition unit 120 acquires a joint angle theta₁ of the first joint unit 202a. Based on posture sensor data output by the second posture sensor 213b, the active environment information acquisition unit 120 acquires a joint angle theta₂ of the second joint unit 202b. The joint angle theta₁ and the joint angle theta₂ shown in FIG. 3 represent angles relative to a horizontal reference. Although such a method of defining angles is not used in actual robotics, it is adopted here for simplicity.

The active environment information acquisition unit 120 acquires a link length l₁ and a link length l₂ based on information indicating link lengths known in advance. The link length l₁ is, for example, a length from the first joint unit 202a to the second joint unit 202b. The link length l₂ is, for example, a length from the second joint unit 202b to the proximity sensor 212 mounted on the tip portion of the arm unit 201. A way of defining each link length is not limited to the example shown in FIG. 3. As long as a depth z can be obtained, each link length can be set arbitrarily.

In the example shown in FIG. 3, using the joint angle theta₁, the joint angle theta₂, the link length l₁, and the link length l₂, the active environment information acquisition unit 120 calculates the depth z from an arbitrary origin, for example a base unit of the arm unit 201, to the target object as in Equation (1) below.

$$[ Math . 1 ]$$

$$z = {l}_{1} cos {θ}_{1} + {l}_{2} cos {θ}_{2} \qquad Equation ( 1 )$$

The active environment information acquisition unit 120 performs three-dimensional reconstruction processing using the acquired depth information and the RGB image and acquires environment information including three-dimensional spatial information related to the target object. For example, the active environment information acquisition unit 120 performs three-dimensional reconstruction processing using Visual SLAM technology and acquires three-dimensional spatial information such as a three-dimensional point cloud or a three-dimensional map indicating a shape, a position, and coordinates of the target object.

In the present example embodiment, both the low accuracy environment information acquisition unit 110 and the active environment information acquisition unit 120 can acquire environment information including three-dimensional spatial information related to a target object. Since the active environment information acquisition unit 120 uses depth information and an RGB image acquired by operating the arm unit 201, the active environment information acquisition unit 120 can acquire environment information with higher accuracy than the low accuracy environment information acquisition unit 110. On the other hand, since the low accuracy environment information acquisition unit 110 does not operate the arm unit 201 to acquire depth information and an RGB image and does not perform three-dimensional reconstruction processing using those data, the low accuracy environment information acquisition unit 110 can acquire environment information faster and with lower load than the active environment information acquisition unit 120. Three-dimensional spatial information acquired by the active environment information acquisition unit 120 and three-dimensional spatial information acquired by the low accuracy environment information acquisition unit 110 may have the same format or may have different formats.

The operation plan generation unit 130 generates an operation plan based on task definition information in which a task to be executed by a robot is defined, the task corresponding to a work goal, and on environment information acquired by the low accuracy environment information acquisition unit 110 or the active environment information acquisition unit 120.

A format of the task definition information may be any format. Examples of the format of the task definition information include a format defined graphically, a format that specifies a final posture or joint angles of the robot 200 or the arm unit 201, and a format defined by a dedicated artificial language or a natural language, but are not limited to these. The format of task definition information that can be input to the operation plan generation unit 130 is not limited to these.

The operation plan includes, for example, control target trajectory information that indicates a control target trajectory to perform a specific operation by the robot 200 or the arm unit 201. In a task of picking a target object, the operation plan may include information indicating a grasping point for grasping the target object. The control target trajectory information is represented, for example, in a format indicating a state of the robot 200 or the arm unit 201 in time series.

The control unit 140 controls the robot 200 in accordance with the operation plan generated by the operation plan generation unit 130.

When predetermined conditions are satisfied, the control unit 140 controls the robot 200 in accordance with an operation plan generated based on environment information acquired by the active environment information acquisition unit 120. On the other hand, when the predetermined conditions are not satisfied, the control unit 140 controls the robot 200 in accordance with an operation plan generated based on environment information acquired by the low accuracy environment information acquisition unit 110. That is, the robot control system 100 of the present example embodiment is configured to allow the active environment information acquisition unit 120 and the low accuracy environment information acquisition unit 110 to acquire environment information by methods that differ in accuracy and acquisition speed, and to use them selectively according to a situation.

The predetermined conditions are, for example, a state in which control of the robot 200 based on an existing operation plan cannot be normally completed. This can be regarded as a state in which the task cannot be completed by the existing operation plan for one task. That is, when control of the robot 200 for one task cannot be normally completed based on an existing operation plan, it is determined that the predetermined conditions are satisfied. On the other hand, when control of the robot 200 for one task can be normally completed based on an existing operation plan, or when it is unknown whether it can be completed, or when an existing operation plan does not exist, it is determined that the predetermined conditions are not satisfied. Therefore, only when control of the robot 200 for one task cannot be normally completed based on an existing operation plan, the control unit 140 controls the robot 200 in accordance with an operation plan based on environment information acquired by the active environment information acquisition unit 120. In other cases, the control unit 140 controls the robot 200 in accordance with an operation plan based on environment information acquired by the low accuracy environment information acquisition unit 110.

For example, while the arm unit 201 operates in accordance with an operation plan, the proximity sensor 212 may detect proximity to the target object or another object. When a distance to this object is less than a predetermined distance, the control unit 140 may determine that control of the robot 200 based on the existing operation plan cannot be normally completed. A case in which a distance to an object is less than a predetermined distance is, for example, a case in which the object is approaching a distance that is not assumed in the operation plan. The control unit 140 may also determine that control of the robot 200 based on the existing operation plan cannot be normally completed when a difference between a detected position of an object and a position of the object in environment information on which the operation plan is premised exceeds a predetermined threshold.

The predetermined conditions of the present example embodiment are not limited to those described above. For example, the predetermined conditions may be that an active acquisition of environment information is set effective. That is, when a setting to actively acquire environment information is effective, the control unit 140 controls the robot 200 in accordance with an operation plan based on environment information acquired by the active environment information acquisition unit 120. On the other hand, when such a setting is not made, the control unit 140 controls the robot 200 in accordance with an operation plan based on environment information acquired by the low accuracy environment information acquisition unit 110. This setting may be defined by a user or may be automatically defined based on environment information, operation plans, and control results based on operation plans acquired in the past.

When the control unit 140 determines that control of the robot 200 based on the operation plan cannot be normally completed, the control unit 140 stops operation of the robot 200. The control unit 140 also outputs an acquisition instruction signal to the active environment information acquisition unit 120 to instruct acquisition of environment information. Thereafter, the control unit 140 controls the robot 200 in accordance with an operation plan generated based on environment information acquired by the active environment information acquisition unit 120.

When control of the robot 200 in accordance with the operation plan is normally completed, the control unit 140 outputs information indicating completion of the task. For example, the control unit 140 outputs and stores information indicating completion of the task in a storage unit inside or outside the robot control system 100, which is not illustrated. The control unit 140 also outputs information indicating completion of the task to a display device such as a display device not illustrated to display it.

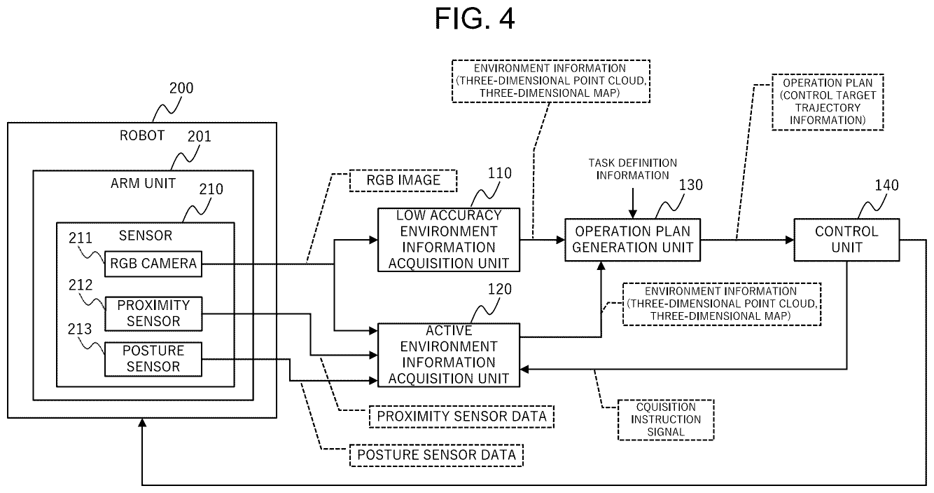

Next, an outline of the robot control system according to the present disclosure is explained. FIG. 4 is an explanatory diagram that explains an outline of operations of the robot control system. FIG. 4 is an explanatory diagram to facilitate understanding of the outline of operations of the robot control system. Therefore, a configuration and operations of the robot control system are not limited to those shown in FIG. 4. Arrows in FIG. 4 succinctly indicate directions of flows of signals data, but do not exclude bidirectionality. This also applies to other drawings.

As shown in FIG. 4, the low accuracy environment information acquisition unit 110 inputs, for example, an RGB image of a target object captured by the RGB camera 211. This RGB image is an image in which an overall scene of a work environment including the target object is captured, for example. The low accuracy environment information acquisition unit 110 may input an RGB image acquired by an RGB camera different from the RGB camera 211 mounted on the arm unit 201. This different RGB camera is a camera installed at a position from which an environment where the robot 200 performs work can be viewed at a glance, for example, and capable of imaging an overall scene of a work environment including the target object. Next, based on this RGB image, the low accuracy environment information acquisition unit 110 acquires environment information including three-dimensional spatial information such as a three-dimensional point cloud or a three-dimensional map.

The operation plan generation unit 130 inputs the environment information acquired by the low accuracy environment information acquisition unit 110 and the task definition information and generates an operation plan based on this information. The task definition information is stored in advance, for example, in the robot control system 100 or in an external storage unit (not shown).

The control unit 140 controls the robot 200 in accordance with the operation plan generated by the operation plan generation unit 130. When the predetermined conditions are not satisfied, the control unit 140 controls the robot 200 in accordance with an operation plan generated based on environment information acquired by the low accuracy environment information acquisition unit 110. For example, when the state is not a state in which control of the robot 200 based on the existing operation plan cannot be normally completed, the control unit 140 controls the robot 200 in accordance with an operation plan generated based on environment information acquired by the low accuracy environment information acquisition unit 110.

Thereafter, when the control unit 140 determines that the state is a state in which control of the robot 200 based on the operation plan cannot be normally completed, the control unit 140 stops operation of the robot 200. The control unit 140 also transmits an acquisition instruction signal to the active environment information acquisition unit 120 to instruct acquisition of environment information.

Upon receiving the acquisition instruction signal from the control unit 140, the active environment information acquisition unit 120 operates the arm unit 201 to acquire depth information and an RGB image. The active environment information acquisition unit 120 acquires proximity sensor data and posture sensor data from the proximity sensor 212 and the posture sensor 213 mounted on the arm unit 201. The active environment information acquisition unit 120 also acquires an RGB image from the RGB camera 211 mounted on the arm unit 201.

The active environment information acquisition unit 120 acquires depth information by calculating a distance to the target object based on the acquired proximity sensor data and posture sensor data. Specifically, the active environment information acquisition unit 120 operates the arm unit 201 in various directions and postures until the proximity sensor 212 detects proximity to the target object or the like, and when the proximity sensor 212 detects proximity, the active environment information acquisition unit 120 stops operation of the arm unit 201. The active environment information acquisition unit 120 also acquires posture sensor data indicating a posture of the arm unit 201 at that time. Then, based on a joint angle of a joint unit of the arm unit 201 included in the posture sensor data and a link length known in advance, the active environment information acquisition unit 120 calculates a distance between an arbitrary origin and the target object. In this way, the active environment information acquisition unit 120 actively approaches the target object repeatedly and acquires depth information based on a posture of the arm unit 201 at the time when proximity is detected, that is, joint angles of the joint units.

Subsequently, the active environment information acquisition unit 120 acquires environment information including three-dimensional spatial information such as a three-dimensional point cloud or a three-dimensional map based on the depth information and the RGB image.

The operation plan generation unit 130 generates a new operation plan based on the environment information acquired by the active environment information acquisition unit 120 and the task definition information. Next, the control unit 140 controls the robot 200 in accordance with this new operation plan.

As described above, when predetermined conditions are satisfied, for example when control of the robot 200 based on the existing operation plan cannot be normally completed, the active environment information acquisition unit 120 acquires environment information. Then, the control unit 140 switches to an operation plan generated based on environment information acquired by the active environment information acquisition unit 120 and controls the robot 200.

### Explanation of Operations

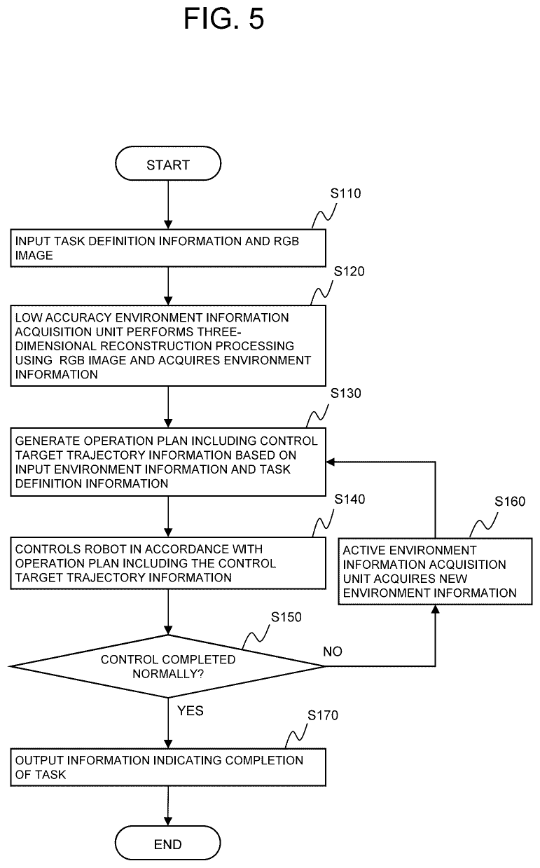

Next, operations of the robot control system are explained. FIG. 5 is a flowchart that explains operations of the robot control system.

The robot control system 100 inputs task definition information and an RGB image (step S110). For example, the operation plan generation unit 130 inputs the task definition information, and the low accuracy environment information acquisition unit 110 inputs an RGB image of a target object acquired by the RGB camera 211 mounted on the arm unit 201.

Next, the low accuracy environment information acquisition unit 110 performs three-dimensional reconstruction processing using the RGB image and acquires environment information (step S120). The low accuracy environment information acquisition unit 110 outputs the acquired environment information to the operation plan generation unit 130.

Next, the operation plan generation unit 130 generates an operation plan including control target trajectory information based on the input environment information and the task definition information (step S130).

Next, the control unit 140 controls the robot 200 in accordance with the operation plan including the control target trajectory information generated by the operation plan generation unit 130 (step S140).

When control of the robot 200 is normally completed (step S150: YES), the control unit 140 outputs information indicating completion of the task (step S170). Thereafter, processing of the robot control system 100 ends.

On the other hand, when control of the robot 200 cannot be normally completed (step S150: NO), the control unit 140 stops operation of the robot 200 and transmits an acquisition instruction signal to the active environment information acquisition unit 120 to instruct acquisition of environment information. Upon receiving the acquisition instruction signal, the active environment information acquisition unit 120 operates the arm unit 201 to acquire depth information and an RGB image and acquires new environment information (step S160). The active environment information acquisition unit 120 outputs the acquired environment information to the operation plan generation unit 130. Thereafter, processing of the robot control system 100 returns to step S130.

When an operation plan based on environment information acquired by the active environment information acquisition unit 120 cannot be normally completed (step S150: NO), the robot control system 100 executes processing of steps S160, S130, and S140 again.

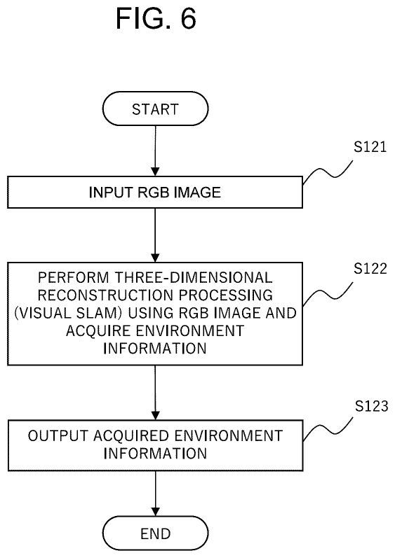

Next, details of operations of the low accuracy environment information acquisition unit 110 in step S120 are explained. FIG. 6 is a flowchart that explains operations of the low accuracy environment information acquisition unit.

The low accuracy environment information acquisition unit 110 inputs an RGB image of a target object acquired by the RGB camera 211 mounted on the arm unit 201 (step S121).

Next, the low accuracy environment information acquisition unit 110 performs three-dimensional reconstruction processing using the RGB image and acquires environment information including three-dimensional spatial information related to the target object (step S122). For example, the low accuracy environment information acquisition unit 110 performs three-dimensional reconstruction processing using Visual SLAM technology.

Next, the low accuracy environment information acquisition unit 110 outputs the acquired environment information to the operation plan generation unit 130 (step S123).

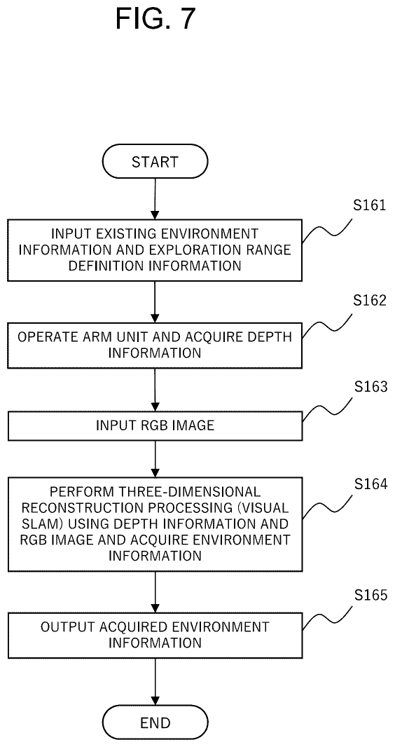

Next, details of operations of the active environment information acquisition unit 120 in step S160 are explained. FIG. 7 is a flowchart that explains operations of the active environment information acquisition unit.

The active environment information acquisition unit 120 inputs existing environment information and exploration range definition information (step S161). The exploration range definition information is stored in advance, for example, in the robot control system 100 or in an external storage unit (not shown).

Next, the active environment information acquisition unit 120 operates the arm unit 201 based on the existing environment information and the exploration range definition information and acquires depth information indicating a distance to the target object based on acquired sensor data (step S162). Specifically, the active environment information acquisition unit 120 acquires proximity sensor data and posture sensor data at a time when the proximity sensor 212 mounted on the arm unit 201 detects proximity. Based on the acquired proximity sensor data and posture sensor data, the active environment information acquisition unit 120 calculates a distance between an arbitrary origin and the target object.

Next, the active environment information acquisition unit 120 inputs an RGB image of the target object acquired by the RGB camera 211 mounted on the arm unit 201 (step S163).

Next, the active environment information acquisition unit 120 performs three-dimensional reconstruction processing using the depth information and the RGB image and acquires environment information including three-dimensional spatial information related to the target object (step S164). For example, the active environment information acquisition unit 120 performs three-dimensional reconstruction processing using Visual SLAM technology.

Next, the active environment information acquisition unit 120 outputs the acquired environment information to the operation plan generation unit 130 (step S165).

Operation examples shown in FIG. 5, FIG. 6, and FIG. 7 do not limit operations of the robot control system 100 according to the present disclosure. For example, when a setting is made to actively acquire environment information, the robot control system 100 may execute processing of step S160 instead of processing of step S120. For example, in processing of steps S161 and S162, the active environment information acquisition unit 120 may operate the arm unit 201 based on either existing environment information or the exploration range definition information.

### Explanation of Effects

Next, effects of the present example embodiment are explained. In the present example embodiment, the active environment information acquisition unit 120 acquires environment information based on depth information acquired by operating the arm unit 201 equipped with the proximity sensor 212 and based on an RGB image of the target object captured by the RGB camera 211 mounted on the arm unit 201. The control unit 140 controls the robot 200 having the arm unit 201 in accordance with an operation plan generated based on the environment information. That is, the robot control system 100 of the present example embodiment uses the RGB camera 211 and the proximity sensor 212, which are less expensive and have a more stable supply than an RGB-D camera or a 3D camera. The robot control system 100 also utilizes the arm unit 201 itself as a depth sensor by using the proximity sensor 212 mounted on the arm unit 201. With such a configuration, the robot control system 100 can achieve robot control at low cost. As a result, a teaching-less robot control system can be achieved at low cost.

In the present example embodiment, the low accuracy environment information acquisition unit 110 acquires environment information based on an RGB image of a target object captured by an RGB camera. When predetermined conditions are satisfied, the control unit 140 controls the robot 200 in accordance with an operation plan generated based on environment information acquired by the active environment information acquisition unit 120. On the other hand, when the predetermined conditions are not satisfied, the control unit 140 controls the robot 200 in accordance with an operation plan generated based on environment information acquired by the low accuracy environment information acquisition unit 110. That is, in the robot control system 100, the active environment information acquisition unit 120 and the low accuracy environment information acquisition unit 110 can acquire environment information by methods that differ in accuracy and acquisition speed, and are configured to be used selectively according to a situation. With such a configuration, environment information can be acquired suitably according to the situation. As a result, a robot control system that performs processing suitably according to the situation is achieved.

In the present example embodiment, the predetermined conditions are, for example, that control of the robot 200 based on the existing operation plan cannot be normally completed. This can be regarded as a state in which the task cannot be completed by the existing operation plan for one task. In this configuration, only when control of the robot 200 for one task cannot be normally completed based on the existing operation plan, the control unit 140 controls the robot 200 in accordance with an operation plan based on environment information acquired by the active environment information acquisition unit 120. On the other hand, in other cases, the control unit 140 controls the robot 200 in accordance with an operation plan based on environment information acquired by the low accuracy environment information acquisition unit 110.

Accordingly, the robot control system 100 first starts control of the robot 200 in accordance with an operation plan based on environment information acquired by the low accuracy environment information acquisition unit 110. When it is determined that control of the robot 200 based on this operation plan cannot be normally completed, the robot control system 100 switches to an operation plan based on environment information acquired by the active environment information acquisition unit 120 and controls the robot 200. That is, the robot control system 100 first acquires environment information by a low accuracy and high speed method, and only when an operation plan based on this environment information cannot be completed, acquires environment information by a high accuracy and low speed method. With such a configuration, environment information can be acquired suitably according to the situation. As a result, a robot control system that performs processing suitably according to the situation is achieved.

In the present example embodiment, the active environment information acquisition unit 120 can acquire depth information by operating the arm unit 201 based on at least one of existing environment information or exploration range definition information in which an exploration range is defined. With such a configuration, the active environment information acquisition unit 120 can perform efficient exploration and can efficiently acquire depth information.

In the present example embodiment, the active environment information acquisition unit 120 calculates a distance to the target object based on posture information indicating a posture of the arm unit 201 at a time when the proximity sensor 212 detects proximity to the target object. The posture information corresponds, for example, to posture sensor data indicating a measurement result by the posture sensor 213, that is, joint angles of the joint units. With such a configuration, the robot control system 100 can utilize the arm unit 201 itself as a depth sensor.

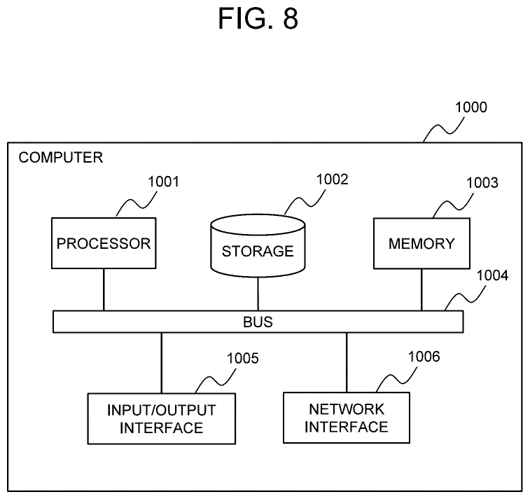

Next, a configuration of a computer according to the present disclosure is explained. FIG. 8 is a block diagram that explains a hardware configuration of a computer 1000 that achieves the robot control system 100, that is, each functional configuration unit of the low accuracy environment information acquisition unit 110, the active environment information acquisition unit 120, the operation plan generation unit 130, and the control unit 140. The computer 1000 is an arbitrary computer. For example, the computer 1000 is a stationary computer such as a personal computer or a server machine. For example, the computer 1000 is a portable computer such as a smartphone or a tablet terminal. The computer 1000 may be a dedicated computer designed to achieve the robot control system 100 or may be a general purpose computer.

The computer 1000 has a processor 1001, a storage device 1002, a memory 1003, a bus 1004, an input and output interface 1005, and a network interface 1006.

The processor 1001 is various processing devices such as a CPU Central Processing Unit, a GPU Graphics Processing Unit, an FPGA Field Programmable Gate Array, and a DSP Digital Signal Processor.

The storage device 1002 is, for example, a non-transitory computer readable medium. The non transitory computer readable medium includes various types of tangible storage media. Specific examples of the non-transitory computer readable medium include semiconductor memories, for example, a mask ROM, a PROM Programmable ROM, an EPROM Erasable PROM, and a flash ROM.

The memory 1003 is a main storage device achieved by using a RAM Random Access Memory or the like. The memory 1003 temporarily stores data when the processor 1001 executes processing.

The bus 1004 is a data transmission path for the processor 1001, the memory 1003, the storage device 1002, the input and output interface 1005, and the network interface 1006 to transmit and receive data to and from each other. However, a method of connecting the processor 1001 and the like to each other is not limited to bus connection.

The input and output interface 1005 is an interface for connecting the computer 1000 and input and output devices. For example, an input device such as a keyboard and an output device such as a display device are connected to the input and output interface 1005.

The network interface 1006 is an interface for connecting the computer 1000 to a network. The network may be a LAN Local Area Network or may be a WAN Wide Area Network.

The storage device 1002 stores a program that achieves each functional configuration unit of the robot control system 100. By reading this program into the memory 1003 and executing it, the processor 1001 achieves each functional configuration unit of the robot control system 100.

The robot control system 100 may be achieved by one computer 1000 or may be achieved by a plurality of computers 1000. In the latter case, configurations of the respective computers 1000 need not be the same and may be different from each other.

Each functional configuration unit of the robot control system 100 may be achieved by a combination of the above hardware and software or may be achieved by hardware, for example a hard-wired electronic circuit.

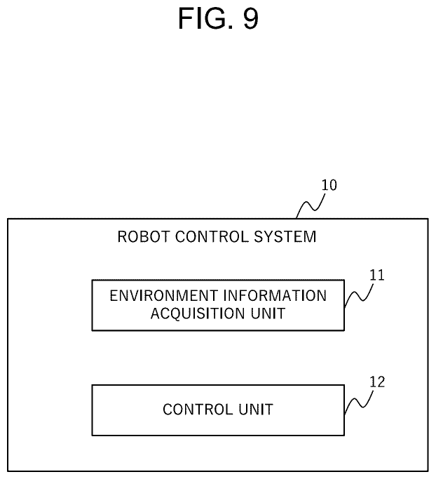

Next, an outline of the present disclosure is explained. FIG. 9 is a block diagram that explains principal parts of the robot control system. A robot control system 10 shown in FIG. 9, for example corresponding to the robot control system 100, includes an environment information acquisition unit 11 (for example, in the example embodiment realized by the active environment information acquisition unit 120) that acquires environment information based on depth information indicating a distance to a target object, the depth information being obtained by operating an arm unit (for example, corresponding to the arm unit 201) equipped with a proximity sensor (for example, corresponding to the proximity sensor 212) capable of detecting proximity of the target object, and based on an RGB image of the target object captured by an RGB camera (for example, corresponding to the RGB camera 211) mounted on the arm unit, and a control unit 12 (for example, in the example embodiment realized by the control unit 140) that controls a robot having the arm unit in accordance with an operation plan generated based on the environment information. With such a configuration, the robot control system 10 can achieve robot control at low cost. As a result, a teaching-less robot control system can be achieved at low cost.

The robot control system 10 may have a configuration including a simple environment information acquisition unit (for example, in the example embodiment realized by the low accuracy environment information acquisition unit 110) that acquires environment information based on an RGB image of a target object captured by an RGB camera. In this case, when predetermined conditions are satisfied, the control unit 12 controls the robot in accordance with an operation plan generated based on environment information acquired by the environment information acquisition unit 11, and when the predetermined conditions are not satisfied, the control unit 12 controls the robot in accordance with an operation plan generated based on environment information acquired by the simple environment information acquisition unit. With such a configuration, the robot control system 10 can acquire environment information by methods that differ in accuracy and acquisition speed by the environment information acquisition unit 11 and the simple environment information acquisition unit. As a result, a robot control system that acquires environment information suitably according to a situation and performs processing is achieved.

The present disclosure has been explained with reference to example embodiments, but the present disclosure is not limited to the above example embodiments. Various changes can be made to a configuration and details of the present disclosure within a scope understood by a person skilled in the art. Each example embodiment can be combined with another example embodiment as appropriate.

Each drawing is merely an example for explaining one or more example embodiments. Each drawing is not associated with only a specific example embodiment and may be associated with one or more other example embodiments. As can be understood by a person skilled in the art, various features or steps explained with reference to any one drawing can be combined with features or steps shown in one or more other drawings, for example to create example embodiments that are not explicitly illustrated or explained. All features or steps shown in any one drawing for explaining an example embodiment are not necessarily essential, and some features or steps may be omitted. An order of steps described in any drawing may be changed as appropriate.

Some or all of the above example embodiments can also be described as the following supplementary notes but are not limited to the following.

### Supplementary Note 1

A robot control system including:
an environment information acquisition unit that acquires environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
a control unit that controls a robot having the arm unit in accordance with an operation plan generated based on the environment information.

### Supplementary Note 2

The robot control system according to Supplementary note 1, further including
a simple environment information acquisition unit that acquires environment information related to the target object based on an RGB image of the target object captured by the RGB camera, wherein
the control unit controls the robot in accordance with an operation plan generated based on environment information acquired by the environment information acquisition unit when predetermined conditions are satisfied, and controls the robot in accordance with an operation plan generated based on environment information acquired by the simple environment information acquisition unit when the predetermined conditions are not satisfied.

### Supplementary Note 3

The robot control system according to Supplementary note 2, wherein
the predetermined conditions are that control of the robot based on an existing operation plan cannot be normally completed.

### Supplementary Note 4

The robot control system according to Supplementary note 2 or Supplementary note 3, wherein
the environment information acquisition unit acquires the depth information by operating the arm unit based on at least one of existing environment information or exploration range definition information in which an exploration range is defined when the predetermined conditions are satisfied.

### Supplementary Note 5

The robot control system according to any one of Supplementary notes 2 to 4, wherein
the simple environment information acquisition unit performs three-dimensional reconstruction processing using the RGB image and acquires environment information including three-dimensional spatial information related to the target object.

### Supplementary Note 6

The robot control system according to any one of Supplementary notes 1 to 5, wherein
the environment information acquisition unit performs three-dimensional reconstruction processing using the depth information and the RGB image and acquires environment information including three-dimensional spatial information related to the target object.

### Supplementary Note 7

The robot control system according to any one of Supplementary notes 1 to 6, wherein
the environment information acquisition unit calculates a distance to the target object based on posture information indicating a posture of the arm unit at a time when the proximity sensor detects proximity to the target object.

### Supplementary Note 8

The robot control system according to any one of Supplementary notes 1 to 7, further including
an operation plan generation unit that generates an operation plan including information indicating a control target trajectory based on task definition information in which a task to be executed by the robot is defined and on the environment information, wherein
the control unit controls the robot in accordance with the operation plan generated by the operation plan generation unit.

### Supplementary Note 9

A robot control method performed by a computer and includes:
acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
controlling a robot having the arm unit in accordance with an operation plan generated based on the environment information.

### Supplementary Note 10

A robot control program for causing a computer to execute:
acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
controlling a robot having the arm unit in accordance with an operation plan generated based on the environment information.

### Supplementary Note 11

A non-transitory computer readable recording medium storing a robot control program executable by a computer to perform processing including:
acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
controlling a robot having the arm unit in accordance with an operation plan generated based on the environment information.

Some or all of the elements (for example, configuration and function) described in Supplementary notes 2 to 8, which are dependent on Supplementary note 1, may also be dependent on Supplementary notes 9, 10 and 11 with the same dependency relationship as in Supplementary notes 2 to 8. Some or all of the elements described in any Supplementary note may be applied to various hardware, software, recording means for recording software, systems, and methods.

1. A robot control system comprising:
a memory storing software instructions; and
one or more processors configured to execute the software instructions to:
acquire environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
control a robot having the arm unit in accordance with an operation plan generated based on the environment information.

2. The robot control system according to claim 1, wherein the one or more processors are further configured to execute the software instructions to
acquire environment information related to the target object based on an RGB image of the target object captured by the RGB camera or by another RGB camera wherein
the one or more processors control the robot in accordance with an operation plan generated based on environment information acquired from the depth information and the RGB image when predetermined conditions are satisfied, and controls the robot in accordance with an operation plan generated based on environment information acquired from the RGB image when the predetermined conditions are not satisfied.

3. The robot control system according to claim 2, wherein
the predetermined conditions are that control of the robot based on an existing operation plan cannot be normally completed.

4. The robot control system according to claim 2, wherein
the one or more processors acquire the depth information by operating the arm unit based on at least one of existing environment information or exploration range definition information in which an exploration range is defined when the predetermined conditions are satisfied.

5. The robot control system according to claim 2, wherein
the one or more processors perform three-dimensional reconstruction processing using the RGB image and acquire environment information including three-dimensional spatial information related to the target object.

6. The robot control system according to claim 1, wherein
the one or more processors perform three-dimensional reconstruction processing using the depth information and the RGB image and acquire environment information including three-dimensional spatial information related to the target object.

7. The robot control system according to claim 1, wherein
the one or more processors calculate a distance to the target object based on posture information indicating a posture of the arm unit at a time when the proximity sensor detects proximity to the target object.

8. The robot control system according to claim 1, wherein the one or more processors are further configured to execute the software instructions to
generate the operation plan including information indicating a control target trajectory based on task definition information in which a task to be executed by the robot is defined and on the environment information, wherein
the one or more processors control the robot in accordance with the operation plan.

9. A robot control method performed by a computer and comprising:
acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
controlling a robot having the arm unit in accordance with an operation plan generated based on the environment information.

10. A non-transitory computer readable medium storing a robot control program executable by a computer to perform processing comprising:
acquiring environment information based on depth information indicating a distance to a target object, the depth information being obtained by operating an arm unit equipped with a proximity sensor capable of detecting proximity of the target object, and based on an RGB image of the target object captured by an RGB camera mounted on the arm unit; and
controlling a robot having the arm unit in accordance with an operation plan generated based on the environment information.

11. The robot control system according to claim 3, wherein
the one or more processors acquire the depth information by operating the arm unit based on at least one of existing environment information or exploration range definition information in which an exploration range is defined when the predetermined conditions are satisfied.

12. The robot control system according to claim 3, wherein
the one or more processors perform three-dimensional reconstruction processing using the RGB image and acquire environment information including three-dimensional spatial information related to the target object.

13. The robot control system according to claim 2, wherein
the one or more processors perform three-dimensional reconstruction processing using the depth information and the RGB image and acquire environment information including three-dimensional spatial information related to the target object.

14. The robot control system according to claim 3, wherein
the one or more processors perform three-dimensional reconstruction processing using the depth information and the RGB image and acquire environment information including three-dimensional spatial information related to the target object.

15. The robot control system according to claim 4, wherein
the one or more processors perform three-dimensional reconstruction processing using the depth information and the RGB image and acquire environment information including three-dimensional spatial information related to the target object.

16. The robot control system according to claim 2, wherein
the one or more processors calculate a distance to the target object based on posture information indicating a posture of the arm unit at a time when the proximity sensor detects proximity to the target object.

17. The robot control system according to claim 3, wherein
the one or more processors calculate a distance to the target object based on posture information indicating a posture of the arm unit at a time when the proximity sensor detects proximity to the target object.

18. The robot control system according to claim 4, wherein
the one or more processors calculate a distance to the target object based on posture information indicating a posture of the arm unit at a time when the proximity sensor detects proximity to the target object.

19. The robot control system according to claim 11, wherein
the one or more processors calculate a distance to the target object based on posture information indicating a posture of the arm unit at a time when the proximity sensor detects proximity to the target object.
